(19) United States
(12) Patent Application Publication
(10) Pub. No.: US 2011/0033277 A1
(43) Pub. Date: Feb. 10, 2011

(54) APPARATUS FOR UNPILING CONTAINERS, PARTICULARLY PASTRY CONTAINERS

(75) Inventor: Emanuele Barosio, Pozzolengo (IT)

Correspondence Address: FISH & RICHARDSON P.C. (AU), P.O BOX 1022, Minneapolis, MN, 55440-1022, US

(73) Assignee: C.M.S. COSTRUZIONE MACCHINE SPECIALI S.R.L., Milano (IT)

(21) Appl. No.: 12/678,100

(22) PCT Filed: Sep. 12, 2008
(86) PCT No.: PCT/IB2008/002413

§ 371 Date: Oct. 21, 2010

(30) Foreign Application Priority Data
Sep. 14, 2007 (IT) MI2007A001767

(51) Int. Cl. B65G 59/10; B65B 43/46

(52) U.S. Cl. 414/795.6

(57) ABSTRACT

An apparatus for unpiling containers includes a bearing structure, gripping members associable with at least one pile of containers for unpiling the containers, first actuating means acting between the bearing structure and the gripping members to move the gripping members from the picking-up station to the laying station and vice versa, and second actuating means acting on the gripping members to move the members away from and close to the picking-up and laying stations. The first actuating means includes a carousel mechanism rotatable about a first axis to transfer each gripping member between the picking-up station and the laying station. The second actuating means is adapted to move each gripping member between a first position corresponding to a maximum distance of the gripping member from the first axis and a second position corresponding to a minimum distance of the gripping member from the first axis.

### TECHNICAL FIELD

The present invention relates to an apparatus for unpiling containers, and in particular containers for food products such as pastry products.

### BACKGROUND

It is known that in the food sector and above all in the confectionery industry, containers known in the art as “bun cases” are used which are made either of smooth or corrugated paper or of paper board, and into which a doughy substance to be baked is poured.

These containers are supplied in packets in which the containers are piled up tightly in contact with each other. There is therefore a requirement not only for automatic feeding and transfer of the bun cases to the operating regions where they are used, but above all for automatic separation of each bun case from the other cases piled up to form a predetermined packet.

The apparatuses designed for unpiling individual bun cases from the respective piled up packets are referred to as “bun case unpiling apparatuses”, and an example of a presently known apparatus of this type is described in the European Patent PE 506 629. This bun case unpiling apparatus operates on piles of these items where the latter are placed on top of a horizontal supporting surface and are disposed on guides along a chute and such oriented that their concavity substantially faces upwards. The apparatus includes a movable port letting a predetermined number of bun cases fall in a regulated manner onto the underlying supporting surface, while the remaining bun cases are retained on sloping guides by a pin element. The bun cases dropped on the supporting surface, still in a piled condition, are still arranged with their concavity facing upwards, and are picked up by an extractor body having an end the shape of which matches that of the bun cases. The end of the extractor body mates with the top bun case and is suitable for reaching a steady matching condition with it due to the pneumatic vacuum action exerted by holes formed in the end, while the other underlying bun cases are retained on the supporting surface by an auxiliary pneumatic vacuum action. The extractor body supporting a single bun case can therefore move in a horizontal and a vertical direction by means of a belt or chain actuating system to lay the bun case in a laying station. During transfer of the individual bun case by the extractor body, the bun case is always maintained with its concavity facing upwards, and at the time of release the vacuum action is replaced by a jet of air under pressure imposing separation of the bun case from the end of the extractor body.

Disadvantageously, the unpiling apparatus is very complicated due to the presence of the belt or chain actuating means in which many transmission shafts are required and tortuous paths are imposed to the belt or chain; in addition it appears to be bulky due to the presence of the extractor body and the necessary spaces for transfer of the bun cases between the supporting surface and the bun case laying station.

Furthermore, an unpiling apparatus as above described allows laying of one bun case at a time, and for the purpose of increasing the apparatus productivity, availability of several apparatuses is required, i.e. as many identical apparatuses are to be arranged in side by side relationship as the number of the bun cases to be simultaneously laid, which will make construction still more complicated and will involve an increase in the overall bulkiness, as a result of the presence of a plurality of extractor bodies, supporting surfaces, actuating belts/chains, and so on.

It is a technical task to make available an apparatus for unpiling containers, in particular pastry containers, that is devoid of the above mentioned drawbacks.

### SUMMARY

Within the scope of this technical task, it is an aim to make available an apparatus for unpiling containers, in particular pastry containers, enabling a high productivity while at the same time having a reduced overall bulkiness.

Another aim is to make available an actuating system allowing the whole apparatus to be actuated in a quick and simple manner, with constant co-ordination and reliability

A still further aim is to provide an apparatus for unpiling containers, in particular pastry containers, that is of simple and practical construction.

The foregoing and still further aims that will become more apparent in the following of the present specification, are substantially achieved by an apparatus for unpiling containers, in particular pastry containers as described herein.

In a further aspect, the above mentioned aims and still others are substantially achieved by an apparatus for unpiling containers, in particular pastry containers, having features as described herein.

### BRIEF DESCRIPTION OF THE FIGURES

A preferred but not exclusive embodiment of an apparatus for unpiling containers, in particular pastry containers, is now illustrated by way of non-limiting example, with reference to the accompanying drawings, in which:

FIG. 1 shows a plant for confectionery production in which an apparatus for unpiling containers is used;

FIG. 2 is a perspective view of part of an apparatus for unpiling containers;

FIGS. 3a-3e show a side view of the portion seen in FIG. 2 according to an operating sequence;

FIG. 4 is a section view of the portion seen in FIGS. 3a to 3e along the line IV-IV in FIG. 3e, with some parts removed in order to make others more prominent;

FIG. 5 is a section view of the portion shown in FIG. 4 along the line V-V in FIG. 4, with some parts removed in order to make others more prominent.

### DETAILED DESCRIPTION

An unpiling apparatus is denoted by reference numeral 1 in the attached drawings. Preferably, although not exclusively, the unpiling apparatus 1 can be used in plants for producing food products and in particular sweets such as biscuits, muffins, plum-cakes and the like.

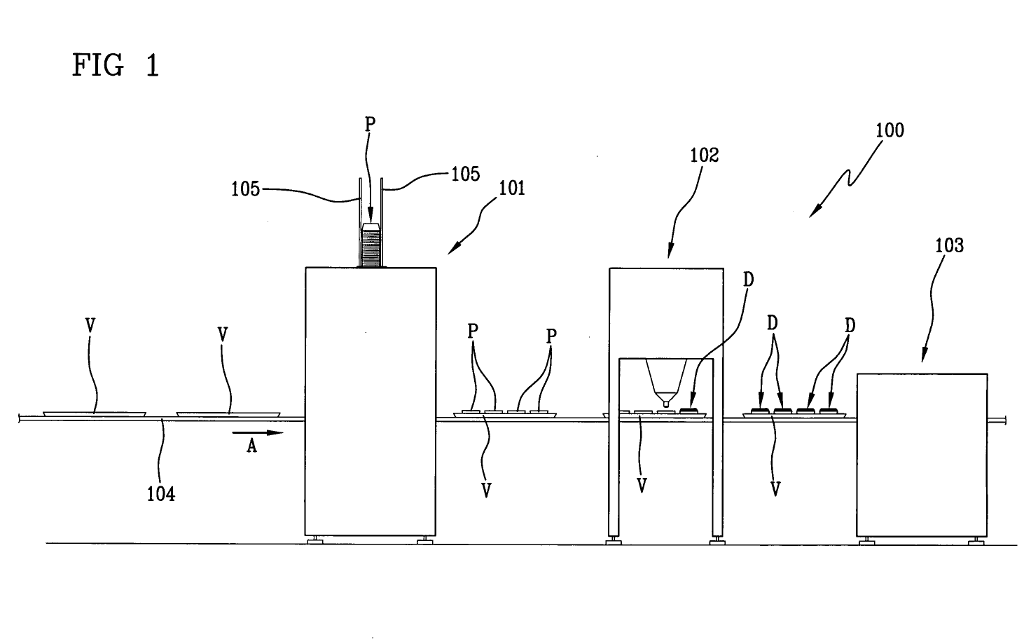

FIG. 1 shows a plant for the confectionery industry, identified with reference numeral 100 and only given by way of example, which is used for preparation of the sweets. In particular, plant 100 includes an unpiling station 101, a filling station 102 and a baking station or oven 103, disposed in the above order. The plant includes a conveyor 104, of the belt or roller type, which crosses the stations 101, 102, 103 and determines a connecting vector between them. The unpiling station 101 includes an unpiling apparatus 1, which will be described in detail in the following.

The plant is adapted to move a plurality of trays “V” in a rhythmic sequence, between an entrance station not shown and positioned upstream of the unpiling station 101 and an exit station placed downstream of the baking station 103 and not shown too. Conveyor 104 moves trays “V” between the stations 101, 102, 103 in an advancing direction denoted by reference “A” in FIG. 1 in the direction stated by the corresponding arrow.

The unpiling station 101 is adapted to receive a pile of containers “P” at the entry, which are disposed on top of each other and supported by preferably vertical guides 105, and to dispose them in an orderly manner on the trays “V” or more generally on a laying surface, according to a matrix arrangement, for example. Containers “P”, as shown in FIG. 1 and in the other figures, preferably consist of bun cases and are of the type designed to hold and partly surround a respective confectionery product “D” before, during and after baking. However this does not constitute a limitation for use of apparatus 1, which can also be employed for unpiling other different types of containers.

The filling station 102 carries out pouring of a predetermined amount of confectionery product “D” in a semifluid or doughy state, while in the baking station 103 the confectionery product “D” is cooked by heating. Downstream of the baking station 103 other stations not shown can be provided, a station for stuffing the confectionery product “D” or stations for garnishing its surface, for example.

At all events it is to be noted that the bun case unpiling apparatus can be suitably used in fully different production lines and can be in different relationship with the other devices shown in FIG. 1.

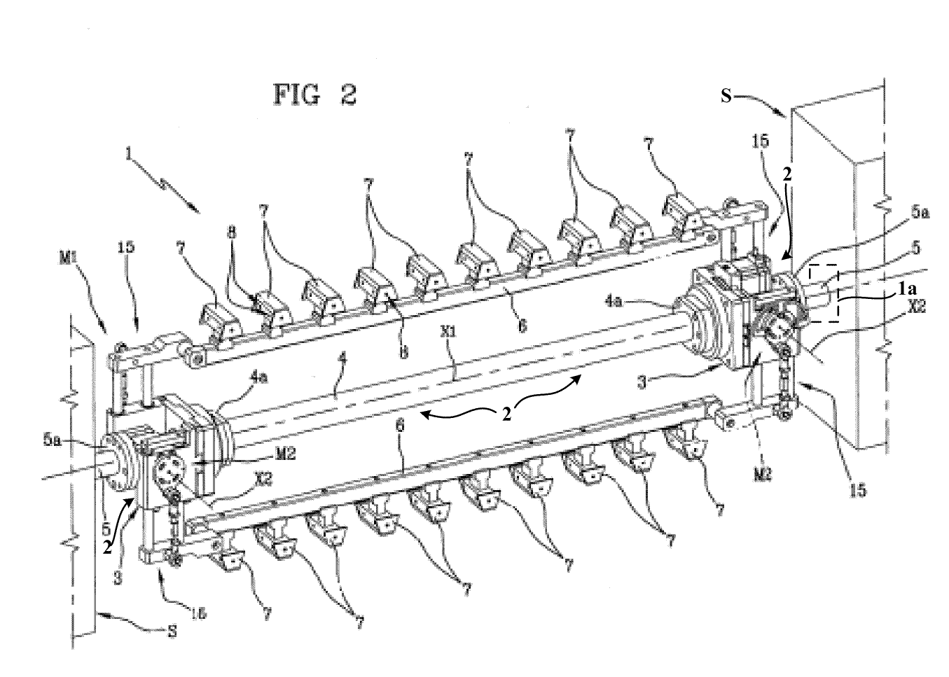

The unpiling apparatus 1 used in the above described unpiling station 101 is shown in detail in FIG. 2 and in the following figures.

The unpiling apparatus 1 includes a carousel mechanism generally denoted by 2 in FIG. 2, which is adapted to rotate about a first axis “X1” which is preferably fixed and more preferably horizontal.

The carousel mechanism 2 is supported at its opposite ends, preferably by means of rolling bearings, by a bearing structure 1a of apparatus 1, which may be an outer casing of apparatus 1, for example.

In more detail, the carousel mechanism 2 includes two drive boxes 3 rigidly connected to each other by a central rod 4 parallel to the first axis “X1”, in such a manner that the two drive boxes 3 are integral with each other in rotation. The unpiling apparatus 1 further includes driving means acting between the bearing structure of apparatus 1 and the carousel mechanism 2 to drive the carousel mechanism in rotation around the first axis “X1”. At least one of the drive boxes 3, preferably both of them, is rigidly connected to an end shaft 5 that can be supported by one of the rolling bearings, or more generally by a support “S” and can be coupled to the driving means. In more detail, the driving means includes an electric motor not shown or any other device adapted to transmit a rotary motion around the first axis “X1” to the drive boxes 3.

In accordance with the embodiment shown in the drawings, each drive box 3 has a pair of opposed flanged portions 3a, 3b that can be steadily coupled by means of threaded connections, on one side to an end flange 5a of a respective end shaft 5 and on the other side to an end flange 4a of the central rod 4.

The carousel mechanism 2 includes a pair of supporting elements 6 aligned parallel with the first axis “X1” and arranged opposite to the first axis “X1”. Each supporting element 6 carries a plurality of gripping members 7 having an outer conformation matching the shape of the containers “P” to be unpiled, and in particular having a trapezoidal section in the embodiment herein shown.

It is however important to point out that the shape of the gripping members 7 may be quite different depending on the container to be picked up (round, square, rectangular, etc.). Each gripping member 7 has a plurality of openings 8 connected to pneumatic means not shown and adapted to generate a pneumatic vacuum action so that, by the vacuum exerted through the openings, the gripping member 7 can retain a respective container “P” on itself until the pneumatic action is stopped.

Preferably, the pneumatic means adapted to generate the vacuum is mounted on the carousel mechanism 2 and therefore this means too rotates around the first axis “X1”.

By rotation of the carousel mechanism 2 around the first axis “X1”, the carousel mechanism 2 is able to pick up a container “P” from a picking-up station 9 disposed above the carousel mechanism 2 and then lay container “P” at a laying station 10 disposed under the carousel mechanism 2, on one of the trays “V”, for example. The carousel mechanism 2 therefore defines first actuating means “M1” acting on the gripping members 7, through the supporting elements 6, for moving the gripping members 7 between the picking-up station 9 and the laying station 10.

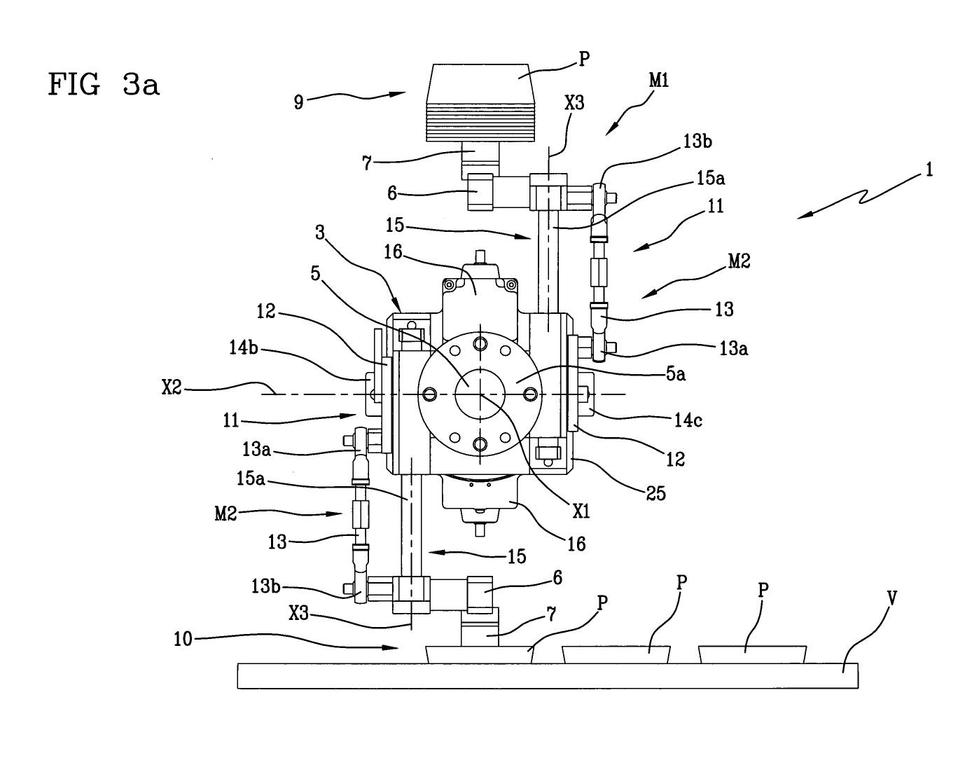

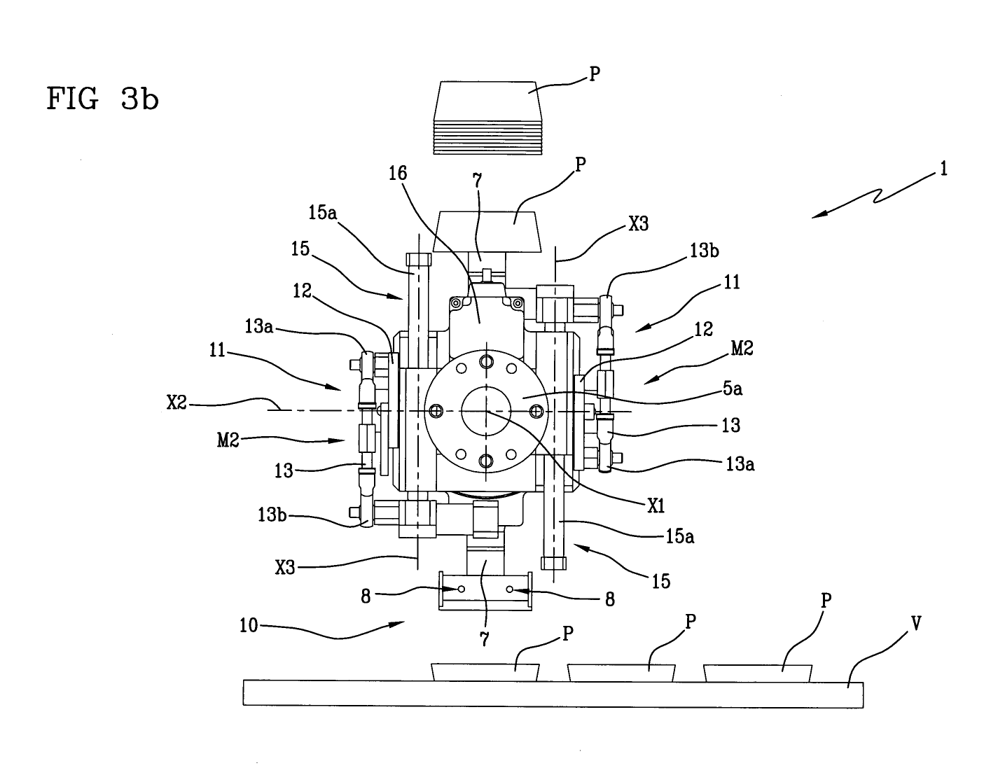

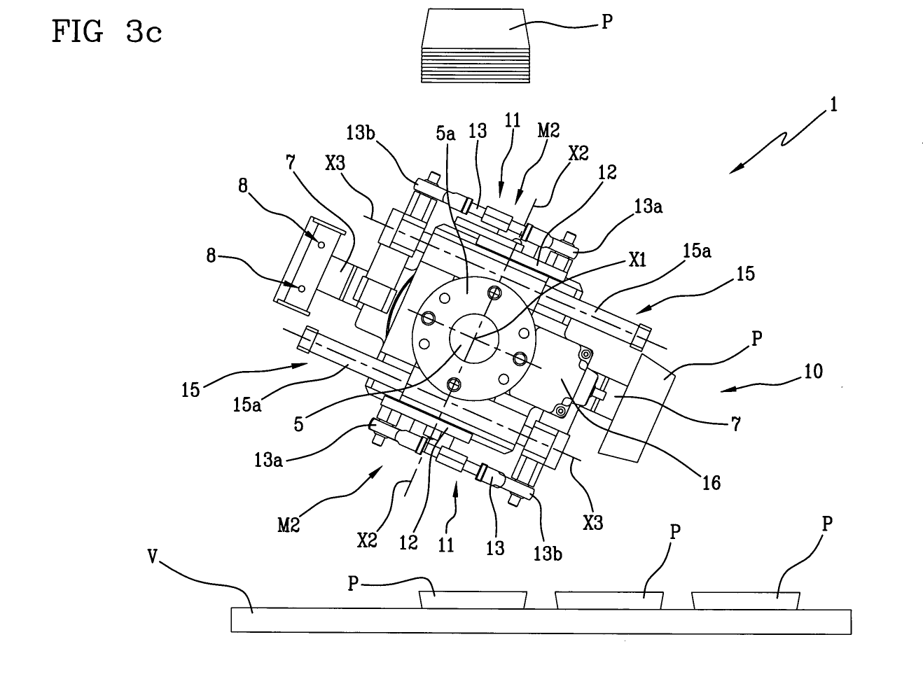

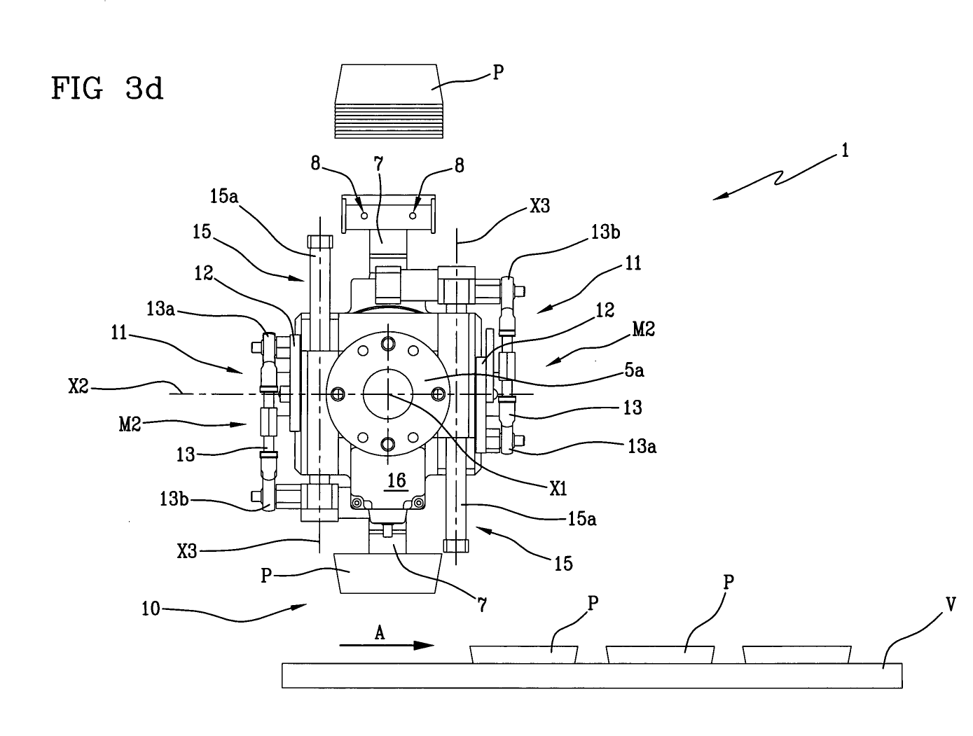

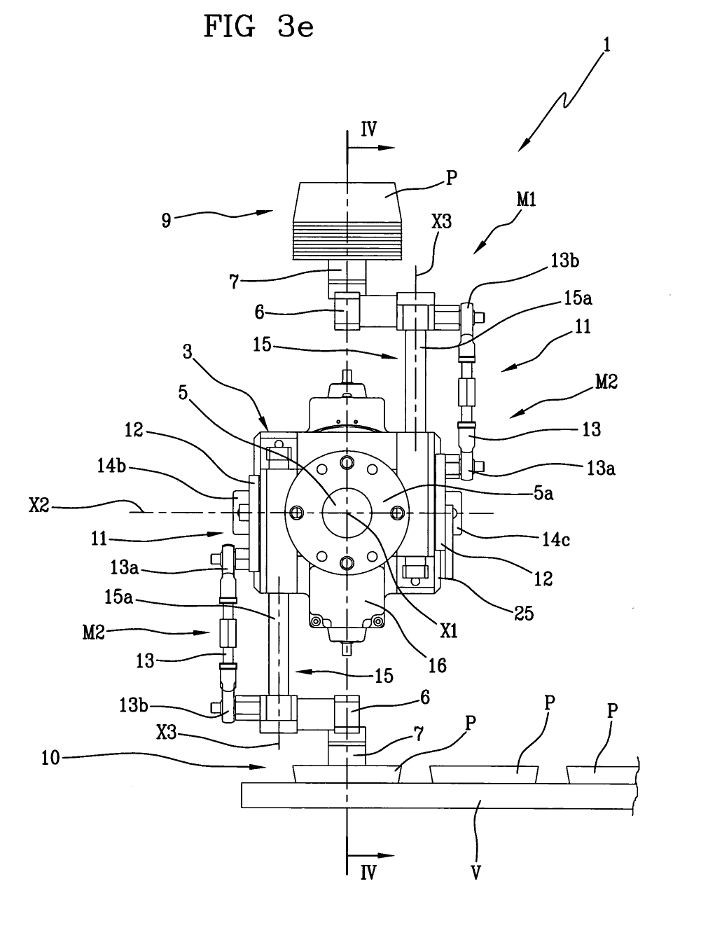

The position of the picking-up and laying stations 9, 10 is better visible in the operating sequence shown in FIGS. 3a to 3e. In these figures it is possible to see that, since the carousel mechanism 2 must cover an angle of half a revolution to move from the picking-up station 9 to the laying station 10, containers “P” are arranged at the top in a piled position with their concavity facing downwards, so that when the containers “P” have been laid on tray “V” they are such oriented that their concavity faces upwards and therefore they are ready for receiving an amount of the semifluid or doughy product “D”. In this case too it is to be pointed out that rotation between the two stations could be equal to an angle different from 180° if stations 9, 10 were disposed at different positions (at 90° from each other, for example).

Containers “P” piled up at the picking-up station 9 are supported by retaining means substantially known and therefore not shown, which allows picking up of the container “P” disposed in the lowermost position while steadily retaining the other overlying containers “P” between the guides 105. By way of example, the retaining means can be of the type equipped with an element as described in European Patent EP 506 629 or also take advantage of frictional forces.

Each supporting element 6 has a major extension size parallel to the first axis “X1” around which the carousel mechanism 2 rotates. Advantageously, in addition, each supporting element 6 is movable close to and away from the first axis “X1”, i.e. the central rod 4, to move the gripping members 7 close to and away from the first axis “X1”. Advantageously, the supporting elements 6 move in the same plane passing through the first axis “X1”. In this way no eccentricity exists between the gripping members 7 and the first axis “X1” during the approaching and moving apart motion of the gripping members 7 relative to the first axis “X1”.

In accordance with the above, the unpiling apparatus 1 includes second actuating means “M2” acting between the carousel mechanism 2 and the gripping members 7 to move the gripping members 7 close to and away from the first axis “X1”. In detail, the second actuating means “M2” is mounted on the carousel mechanism 2, and in particular on the drive boxes 3 and acts between each drive box 3 and the supporting elements 6. More preferably, the second actuating means “M2” acts between each drive box 3 and corresponding ends of the supporting elements 6.

In more detail, the second actuating means “M2” includes a pair of eccentric crank mechanisms 11 for each drive box 3. Each eccentric crank mechanism 11 includes an eccentric crank 12 rotatable with respect to a second axis “X2” perpendicular to the first axis “X1”, and a connecting rod 13 having a first end 13a eccentrically hinged on crank 12 and a second end 13b hinged on the supporting element 6, preferably at an end of the supporting element 6.

The first “X1” and second “X2” axes identify a plane which is a rotary plane during operation of the unpiling apparatus 1. Each drive box 3 carries two eccentric crank mechanisms 11 of the above described type, which are disposed on opposite sides relative to the first axis “X1” and are arranged at the opposite sides of a square in which the two other sides are taken up by the above mentioned flanged portions 3a, 3b. Preferably, the eccentric crank mechanisms 11 associated with the same supporting element 6 have respective eccentric cranks 12 rotating in timed relationship with each other, i.e. adapted to take similar respective positions at a given moment. In this way, the supporting element 6 moves close to and away from the first axis “X1” while being always parallel to the first axis “X1”. More preferably, the eccentric crank mechanisms 11 associated with the same supporting element 6 have respective eccentric cranks 12 rotating about second axes “X2” parallel to each other.

Advantageously, each drive box 3 carries a pair of eccentric cranks 12 which are rotatable around the same second axis “X2”.

Each eccentric crank mechanism 11, by the rotary motion of crank 12 and the translational motion of the connecting rod 13, allows a reciprocating motion of the respective supporting element 6 associated therewith, and therefore a reciprocating motion of the gripping members 7 carried by the supporting element 6. This reciprocating motion that takes place cyclically close to and away from the first axis “X1”, appears like the movement of a piston driven by an ordinary centered crank mechanism. Consequently, each supporting element 6, and therefore each corresponding gripping member 7 is movable between a top dead center, corresponding to a maximum distance from the first axis “X1”, and a bottom dead center, corresponding to a minimum distance from the first axis “X1”.

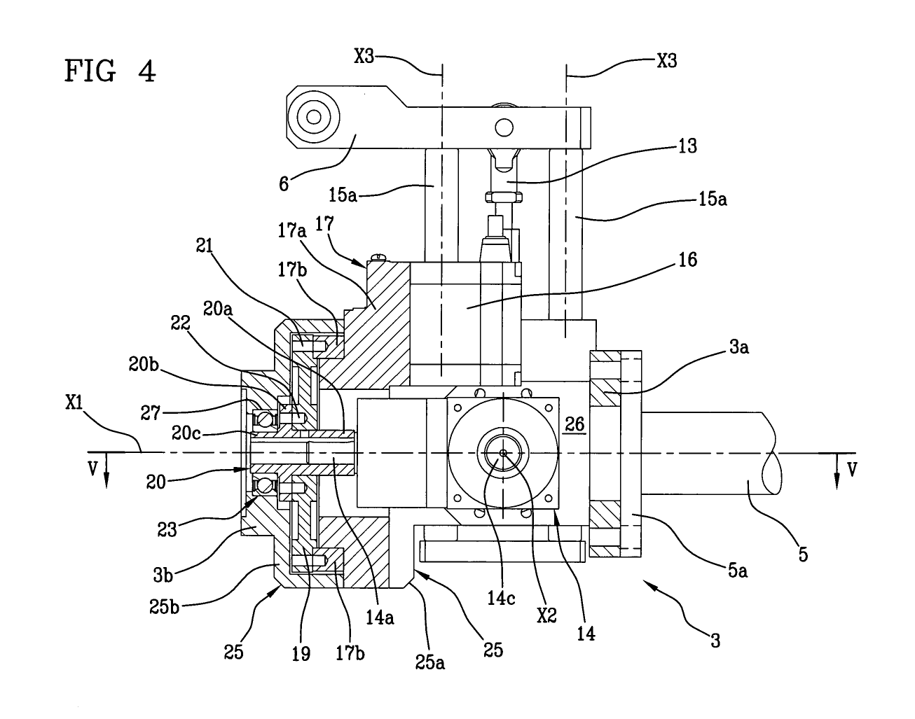

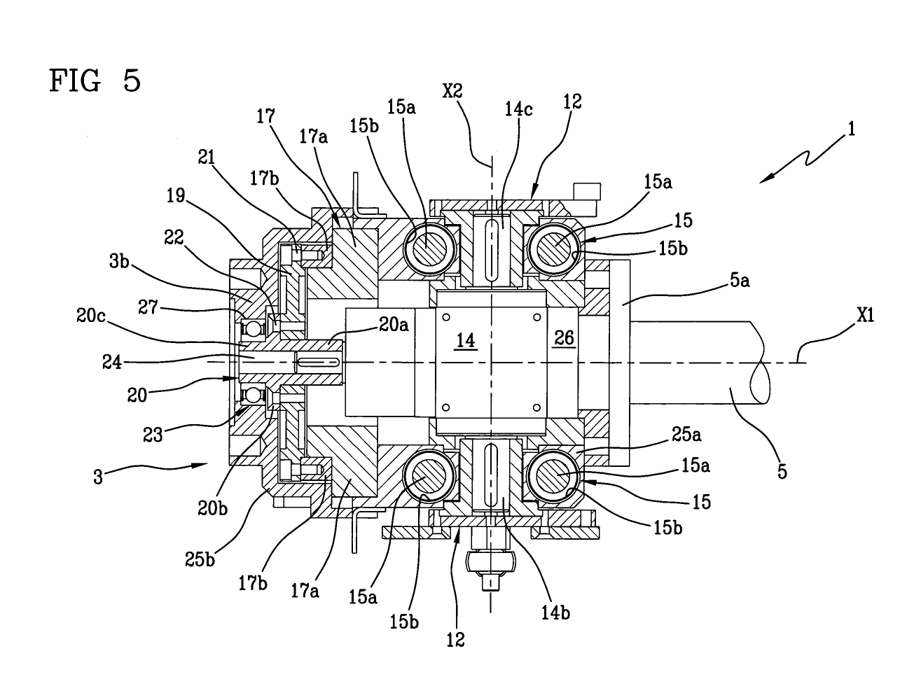

The second actuating means “M2” further includes a pair of angular transmission elements 14, each of which is carried by a respective drive box 3 and preferably enclosed in the drive box 34. Each angular transmission element, as shown in FIGS. 4 and 5, has an input shaft 14a and a pair of output shafts 14b, 14c. The input shaft 14a is placed in alignment with the first axis “X1” of apparatus 1 and rotates about the first axis “X1”, while the output shafts 14b, 14c are in alignment with the same second axis “X2” and rotate about the second axis “X2”. Each angular transmission element 14 is rigidly supported by the respective drive box 3, and the three shafts 14a, 14b, 14c of the angular transmission element 14 are mechanically connected with each other by means of bevel gears not shown as they are part of bevel transmission elements of a substantially known type. In accordance with a first embodiment, the output shafts 14b, 14c are part of a single shaft rotating about the second axis “X2” and coupled to the input shaft 14a by a taper fit so that the two output shafts 14b, 14c always rotate in the same direction relative to each other. In accordance with a second embodiment, the input shaft 14a is connected in a separated manner to the two output shafts 14b, 14c which therefore can only rotate in opposite directions relative to each other. Each output shaft 14b, 14c is steadily connected to a respective eccentric crank 12, preferably by a tongue connection, to rotate about the same second axis “X2”. Therefore, the eccentric cranks 12 of each pair of eccentric crank mechanisms 11 acting on similar respective ends of the supporting elements 6, i.e. on ends facing the same drive box 3, are rotatable about the same second axis “X2”.

In addition, the second actuating means “M2” includes at least one linear guide 15 associated with each eccentric crank mechanism 11. Each linear guide 15 extends along a third axis “X3” defining a Cartesian triad with the first “X1” and second “X2” axes. In other words, each third axis “X3” is oriented in a direction perpendicular to the rotating plane defined by the first axis “X1” and by the second axis “X2” and it too is therefore rotatable relative to the first axis “X1”. The linear guides 15 include a piston 15a slidable in a respective groove 15b formed in each drive box 3. Piston 15a is therefore movable, by the action of a respective eccentric crank mechanism 11, along the third axis “X3” to move close to and/or lower the respective supporting element 6 relative to the first axis “X1”. In accordance with a preferred embodiment, the second actuating means “M2” for each eccentric crank mechanism 11 includes two linear guides 15 parallel to each other and to the third axis “X3”.

FIGS. 4 and 5 show one of the two drive boxes 3 in detail. In particular, each drive box 3 includes a single electric motor 16 being part of the second actuating means “M2”, adapted to move the gripping members 7 close to and away from the first axis “X1”. The electric motor 16 is coupled to a rotating actuator 17 receiving the movement from the electric motor 16 and converting it into a rotational movement about an axis different from the rotation axis of the electric motor 16. In particular, the rotating actuator includes a fixed table 17a rigidly connected to the electric motor 16 and a rotary table 17b of annular shape, driven in rotation by the electric motor 16 relative to the fixed table 17a. The rotating actuator 17 is disposed on the drive box 3 in such a manner that the rotary table 17b is rotatable about an axis coincident with the first axis “X1”. The technical features of the rotating actuator 17, of the so-called “rotary-table” type, will not be discussed in detail as they are substantially of known type among the rotary-table actuators.

The electric motor 16 and rotating actuator 17 are advantageously connected to the angular transmission element 14 of the same drive box 3, and to this aim each drive box 3 includes proper transmission means 18 suitable for movement transmission from the electric motor 16 to the angular transmission element 14, in particular to the input shaft 14a of the latter. The transmission means 18 includes a disc 19 and a sleeve 20. Disc 19 is steadily connected to the rotary table 17b and it too is rotatable about the first axis “X1”, in particular being driven in rotation by the rotary table 17b about the first axis “X1”. At a central portion thereof, disc 19 has a through hole into which sleeve 20 is inserted. Sleeve 20 is steadily connected to disc 19 and is driven in rotation by disc 19 about the first axis “X1”. Sleeve 20 has a first portion 20a inserted in the through hole of disc 19 and a second portion 20b having a greater diameter than the first portion 20a so as to define an abutment against disc 19.

Preferably, first screw threading connections 21 are provided to steadily connect disc 19 to the rotary table 17b and second screw threading connections 22 to connect the second portion 20b of sleeve 20 to disc 19. In this manner, sleeve 20 appears to be driven in rotation by disc 19 and therefore by the electric motor 16.

Sleeve 20 further has a third portion 20c located opposite to the first portion 20b relative to the second portion 20a, which means that the second portion 20b of sleeve 20 is placed between the first 20a and third 20c portions of sleeve 20. The third portion 20c is coupled to a bearing 23 and supported thereby during rotation about the first axis “X1”. The first portion 20a of sleeve 20, preferably the whole sleeve 20, has an inner seat 24 concentric with the first axis “X1” and inside which the input shaft 14a of the angular transmission element 14 can be inserted, by a grooved or tongue coupling. In this way, the electric motor 16 can drive the input shaft 14a of the angular transmission element 14 in rotation through the rotary table 17b, disc 19 and sleeve 20. During rotation of the electric motor 16, the rotary table 17b, disc 19, sleeve 20 and input shaft 14a of the angular transmission element 14 rotate at the same angular speed.

Altogether, disc 19, sleeve 20 and angular transmission element 14, all present on each drive box 3, define a first kinematic mechanism adapted to convert the rotary motion of motor 16 developing around an axis parallel to the first axis “X1” into a rotary motion of the output shafts 14b, 14c of the angular transmission element 14 around the second axis “X2”. The eccentric crank mechanisms 11, on the other hand, define second kinematic mechanisms adapted to convert the rotary motion of the output shafts 14b, 14c around the second axis “X2” into a rectilinear motion of the gripping members 7 along said third axes “X3”.

The drive box 3 further includes an outer casing 25 adapted to define, in co-operation with the electric motor 16 and the rotating actuator 17, an inner space 26 inside which the angular transmission element 14 is housed.

The outer casing 25 includes a first portion 25a placed on one side of the fixed table 17a of the rotating actuator 17 and a second portion 25b placed on the opposite side of the fixed table 17a. The first portion 25a of the outer casing 25 faces the end shaft 5 and has suitable openings to enable the second shafts 14b, 14c of the angular transmission element 14 to come out from the outer casing 25.

The first portion 25a of the outer casing 25 further has one of the flanged portions 3a, 3b for connection to the end shaft 5. The second portion 25b of the outer casing 25 on the contrary extends away from the fixed table 17a of the rotating actuator 17 and supports the other flanged portion 3a, 3b which is connected to the end flange 4a of the central rod 4, not shown in FIGS. 4 and 5 for the sake of clarity. The second portion 25b of the outer casing 25 further has a housing 27 concentric with the first axis “X1” and designed to hold the outer ring of the bearing 23.

The outer casing 25 is further provided with the grooves 15b of the linear guides 15 inside which the respective pistons 15 run.

Operation of the above described unpiling apparatus is now illustrated with the aid of the operating sequence shown in FIGS. 3a to 3e.

The starting position in FIG. 3a shows that the lower gripping members 7 are at the laying station 10 and have just laid the respective containers “P” on tray “V”, whereas the upper gripping members 7 are at the picking-up station 9 and are coupled to the lower container “P” of each container pile to be unpiled. In this position, in the lower gripping members 7 the pneumatic vacuum action is stopped so that containers “P” laid on the tray can be released by the lower gripping members 7; on the contrary, the upper gripping members 7 are submitted to such a pneumatic action that they can retain the respective containers “P”. In the position in FIG. 3a, in addition, all gripping members 7 are at their top dead center, i.e. in the farthest position from the first axis “X1” allowed by the eccentric crank mechanisms 11.

In the subsequent step, shown in FIG. 3b, the second actuating means “M2” is activated to bring the gripping members 7 to their bottom dead center, i.e. to the closest position to the first axis “X1” allowed by the eccentric crank mechanisms 11. Consequently, the gripping members 7 have moved away from the lower containers “P” already laid and from the upper containers “P” to be unpiled. It is therefore possible to impart a rotation to the carousel mechanism 2 to reverse the positions between the upper and lower gripping members 7. In other words, by the first actuating means “M1” a rotation equal to half a revolution is imparted to the carousel mechanism 2, which rotation corresponds to the necessary angle for bringing the gripping members 7 that are at the picking-up station 9, to the laying station 10. The configuration taken by the unpiling apparatus 1 during rotation of the carousel mechanism 2 is shown in FIG. 3c.

FIG. 3b shows the final position reached by the carousel mechanism 2 when rotation has been completed, in which position the location of the gripping members 7 is overturned relative to the location before rotation of the carousel mechanism 2. Under this situation, the gripping members 7 are still at their bottom dead center.

At this point, the second actuating means “M2” is activated again in order to bring the gripping members 7 back to their top dead center, so that the lower gripping members 7 can lay down the previously picked-up containers “P” while the upper gripping members 7 can pick up new containers “P” from the piles to be unpiled, thereby reaching the starting position. Therefore a whole operating cycle of the unpiling apparatus 1 has been completed.

Rotation of the carousel mechanism 2 about the first axis “X1” can always take place either in the same direction or in one direction during a first cycle and in the opposite direction during the subsequent cycle.

In some cases, a single supporting element 6 and therefore a single row of gripping members 7 can be provided. In this case, an operating cycle would require a sequence of steps involving picking up, laying and picking up, instead of involving the picking-up and laying steps carried out simultaneously by the two different rows of supporting members as previously described.

In some cases, it is also possible to provide a single eccentric crank mechanism 11 for each supporting element 6. This eccentric crank mechanism 11 would act on one end of the respective supporting element 6, while only the linear guides 15 would be present at the other end of the supporting element 6 or, alternatively, the last-mentioned end would be devoid both of the eccentric crank mechanism 11 and of the linear guides 15.

Use of a rotating carousel mechanism allows picking up of a plurality of containers or bun cases to be carried out simultaneously with a single apparatus.

In addition, due to the possibility of mounting two opposite rows of gripping members, productivity is doubled since on the one hand the containers can be loaded on the gripping members and simultaneously on the other hand the previously unpiled containers can be laid down. In fact, when a set of gripping members carried by one supporting element is at the picking-up station, another set of gripping members carried by the other supporting member is at the laying station, in such a manner that the two different sets of gripping members operate simultaneously, each on a respective station.

Use of eccentric crank mechanisms, with the motor directly mounted on the carousel mechanism offers a high construction simplicity and also the possibility of adjusting the position of the gripping members relative to the rotation axis of the carousel mechanism, irrespective of the position taken by the carousel mechanism.

The possibility of moving the gripping members close to and away from the first axis, and therefore also close to and away from the picking-up and laying stations, enables the containers to be picked up and laid down in a correct manner while rotation of the carousel mechanism can take place without dangerous interferences occurring between the gripping members and the picking-up and laying stations.

1-22. (canceled)

23. An apparatus for unpiling containers, the apparatus comprising:
a bearing structure;
a plurality of gripping members associable with at least one pile of containers disposed on top of each other, the gripping members being movable between a picking-up station at which each of the gripping members steadily grasps a container being part of the pile, and a laying station at which each gripping member lays the container on a rest surface;
at least one supporting element to which a plurality of the gripping members is fastened, wherein the gripping members are aligned along the first axis;
a first actuator coupled to the bearing structure and the gripping members and operable to move the gripping members from the picking-up station to the laying station and vice versa, wherein the first actuator comprises a carousel mechanism rotatable about a first axis to transfer each gripping member between the picking-up station and the laying station by rotation of the carousel mechanism around the first axis; and
a second actuator carried by the carousel mechanism, wherein the second actuator is coupled to the carousel mechanism and the supporting element, and is operable to move the supporting element toward and away from the first axis and to move each gripping member away from and toward the first axis.

24. The apparatus of claim 23, wherein the second actuator comprises at least one eccentric crank mechanism adapted to move each gripping member between an upper dead center, corresponding to a maximum distance of the gripping member from the first axis, and a lower dead center corresponding to a minimum distance of the gripping member from the first axis.

25. The apparatus of claim 24, wherein the eccentric crank mechanism comprises:
an eccentric crank perpendicular to the first axis; and
a connecting rod having a first end eccentrically hinged on the crank and a second end associated with the gripping member.

26. The apparatus of claim 24, wherein each gripping member seats at its upper dead center when it reaches the picking-up station and the laying station, and seats at its lower dead center during transfer between the picking-up and the laying stations.

27. The apparatus of claim 25, wherein the second actuator further comprises an electric motor acting on each eccentric crank mechanism for determining a movement of the gripping members from the upper to the lower dead centers and vice versa.

28. The apparatus of claim 24, wherein the second actuator comprises at least two eccentric crank mechanisms, each of them being associated with a respective gripping member.

29. The apparatus of claim 27, wherein the electric motor acts on at least two eccentric crank mechanisms, the eccentric cranks of the eccentric crank mechanisms connected to the same electric motor being rotatable about the same second axis.

30. The apparatus of claim 24, wherein the apparatus comprises at least one angular transmission element carried by the carousel mechanism and associated with a pair of eccentric crank mechanisms, the angular transmission element having an input shaft adapted to receive a driving action from a respective electric motor, and a pair of output shafts aligned along the same axis and receiving a driving action from the input shaft through bevel gears, each of the output shafts being connected to the eccentric crank of one of the eccentric crank mechanisms to drive the crank in rotation about the second axis.

31. The apparatus of claim 30, wherein the electric motor determines a relative rotation of the input shaft relative to the carousel mechanism, and the input shaft is rotatable concentrically about the first axis.

32. The apparatus of claim 23, wherein the apparatus comprises two supporting elements disposed on the carousel mechanism in such a manner that when one of the supporting elements faces the picking-up station the other supporting element faces the laying station, wherein the supporting elements are disposed at diametrically opposite positions relative to the first axis.

33. The apparatus of claim 32, wherein each eccentric crank mechanism is associated with a different supporting element and acts on one end of the respective supporting element.

34. The apparatus of claim 32, wherein the second actuator comprises two eccentric crank mechanisms for each supporting element, and the two eccentric crank mechanisms act on opposite ends of the supporting element.

35. The apparatus of claim 33, wherein the eccentric crank of each eccentric crank mechanism acting on a supporting element is in timed relationship with the eccentric crank of the other eccentric crank mechanism acting on the same supporting element, wherein the eccentric cranks of the eccentric crank mechanisms associated with the same supporting element are rotatable about respective second axes parallel to each other.

36. The apparatus of claim 32, wherein the apparatus comprises two angular transmission elements, each of them being associated with a pair of eccentric crank mechanisms acting on respective supporting elements, each angular transmission element having an input shaft adapted to receive a driving action from a respective electric motor, and a pair of output shafts aligned on the same second axis and receiving a driving action from the input shaft through bevel gears, each of the output shafts being connected to the eccentric crank of one of the eccentric crank mechanisms to drive the crank in rotation about the second axis.

37. The apparatus of claim 23, wherein the gripping members are disposed on the carousel mechanism in such a manner that when a first set of gripping members is positioned at the picking-up station, a second set of gripping members is positioned at the laying station.

38. The apparatus of claim 37, wherein the first and second sets of gripping members are carried by two different supporting elements, particularly the first and second sets being disposed at diametrically opposite positions relative to the first axis.

39. The apparatus of claim 23, wherein the first axis is fixed.

40. The apparatus of claim 23, wherein the first axis lies in a horizontal direction.

41. An apparatus for unpiling containers, the apparatus comprising:
a bearing structure;
a plurality of gripping members associable with at least one pile of containers disposed on top of each other, the gripping members being movable between a picking-up station, at which each of the gripping members steadily grasps a container of the pile, and a laying station, at which each gripping member lays the container on a rest surface;
a first actuator coupled to the bearing structure and the gripping members and operable to move the gripping members from the picking-up station to the laying station and vice versa, the first actuator comprising a carousel mechanism rotatable about a first axis to transfer each gripping member between the picking-up station and the laying station by rotation of the carousel mechanism around the first axis; and
a second actuator carried by the carousel mechanism and coupled to the carousel mechanism and the gripping members, wherein the second actuator is operable to move each gripping member away from and toward the first axis, the second actuator being adapted to move each gripping member between a first position corresponding to a maximum distance of the gripping member from the first axis and a second position corresponding to a minimum distance of the gripping member from the first axis.

42. An apparatus for unpiling containers, the apparatus comprising:
a bearing structure;
a plurality of gripping members associable with at least one pile of containers disposed on top of each other, the gripping members being movable between a picking-up station, at which each of the gripping members steadily grasps a container of the pile, and a laying station at which each gripping member lays the container on a rest surface;
a carousel mechanism mounted on the bearing structure and rotatable about a first axis to transfer each gripping member between the picking-up station and the laying station;
at least one electric motor carried by the carousel mechanism;
a first kinematic mechanism carried by the carousel mechanism and adapted to convert a rotary motion of the motor into a rotary motion of at least one rotating shaft about a second axis transverse to the first axis; and
at least one second kinematic mechanism carried by the carousel mechanism and adapted to convert the rotary motion of the rotating shaft about the second axis into a rectilinear motion of the gripping members along respective third axes, the third axes defining a Cartesian triad with the first axis and second axis.
